(19) United States
(12) Patent Application Publication
(10) Pub. No.: US 2010/0275143 A1
(43) Pub. Date: Oct. 28, 2010

(54) On-screen display system and method

(75) Inventors: Yao Yuan Fu, Shenzhen (CN); Jian Tao Tian, Shenzhen (CN); Zhi Jun He, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Shenzhen TCL New Technology Ltd.

(21) Appl. No.: 12/461,490

(22) Filed: Aug. 13, 2009

(30) Foreign Application Priority Data
Apr. 24, 2009 (CN) 200910107124.9

(51) Int. Cl. G06F 3/048

(52) U.S. Cl. 715/768; 715/841

(57) ABSTRACT

A method for operating an OSD capable system includes receiving video information from a video source and receiving OSD image information including a plurality of menus with different menu levels. The method also includes determining transparency degrees of the plurality of menus and generating an output signal to be displayed on a display terminal. The output signal represents the video information superimposed by the plurality of menus with the determined transparency degrees.

### CROSS REFERENCE TO RELATED APPLICATIONS

This application claims the benefit of priority from prior Chinese Patent Application No. 200910107124.9, filed on Apr. 24, 2009, the entire contents of which are incorporated herein by reference.

### TECHNICAL FIELD

The present invention relates generally to display technology and, more particularly, to methods and systems using on-screen display (OSD) techniques.

### BACKGROUND

On-screen display (OSD) technology was developed to display an image superimposed on a screen picture, the image containing information such as volume, channel, and time for various electronic devices such as televisions, video cassette recorders (VCRs), digital video disk (DVD) players, etc. With recent progress in the consumer electronics industry, OSD technology is being used in many types of electronic devices, such as computers and other digital devices, and may also be used in other fields such as digital broadcasting and cable networks.

To use the OSD technology, a system may include an OSD module or device and define two layers of information for display as a video layer and a graphic layer. The graphic layer displays graphic content corresponding to functional interfaces of the system, such as menu, volume, color, etc., and the video layer displays video content. The OSD module may superimpose the graphic content of the graphic layer onto the video content of the video layer, and display the video content with the graphic content superimposed thereon.

Certain conventional OSD techniques simply superimpose an opaque graphic layer on the video layer, which may result a part of the video content being occluded by the graphic content. That is, the occluded part of the video content is not visible to users when the graphic functional interfaces are displayed.

Certain other conventional OSD techniques use a so-called alpha combination to add transparency to the graphic content so that a user can still see what is displayed in the video layer when using the OSD functional interfaces. The alpha combination usually requires an alpha data memory to enable accurate control of the display of both the video layer and the graphic layer pixel by pixel based on the degree of transparency of the graphic content. However, because the transparency of each pixel of the superimposed graphic and video content needs to be calculated using the memory, such OSD techniques often need a large amount of memory and represent a significant computational load. The large memory requirement and significant computational load may be costly and/or computationally impractical for certain systems. Further, for such techniques, the OSD functional interfaces, such as OSD menus, often have the same transparency for all the OSD functional interfaces.

Certain other techniques have been developed to set transparency of an OSD menu. For example, U.S. Pat. No. 6,111,614 issued to Mugura et al. on Aug. 29, 2000, describes a method and apparatus for displaying an electronic menu. The electronic menu includes a number of menu components, alphanumeric characters, and icons displayed on a background, with different levels of transparency applied to the different menu components such that the number of opaque menu components is minimized. However, the same transparency or transparency scheme, once determined for the electronic menu, is applied to different menus.

Methods and systems consistent with certain features of the disclosed embodiments address one or more of the problems set forth above.

### SUMMARY

An example in accordance with the present disclosure includes a method for operating an OSD capable system. The method includes receiving video information from a video source and receiving OSD image information including a plurality of menus with different menu levels. The method also includes determining respective transparency degrees of the plurality of menus and generating an output signal to be displayed on a display terminal. The output signal represents the video information superimposed by the plurality of menus with the determined transparency degrees.

Another example in accordance with the present disclosure includes an OSD capable system. The system includes a video input unit configured to receive video information from a video source, and an OSD image input unit configured to receive OSD image information including a plurality of menus having different menu levels. The system also includes a transparency processing unit coupled to the video input unit and the OSD image input unit and configured to determine respective transparency degrees of the plurality of menus based on the different menu levels. Further, the system includes an adder coupled to the transparency processing unit to provide an output signal to be displayed. The output signal represents the video information superimposed by the plurality of menus with the determined transparency degrees.

It is to be understood that both the foregoing general description and the following detailed description are exemplary and explanatory only and are not restrictive of the invention, as claimed.

### BRIEF DESCRIPTION OF THE DRAWINGS

FIG. 1 shows an exemplary OSD display screen consistent with disclosed embodiments;

FIG. 2 shows an exemplary electronic system incorporating features consistent with disclosed embodiments;

FIG. 3 shows an exemplary controller consistent with disclosed embodiments;

FIG. 4 shows an exemplary operational process consistent with disclosed embodiments;

FIG. 5 another exemplary electronic system incorporating features consistent with disclosed embodiments; and

FIG. 6 illustrates another exemplary operational process consistent with disclosed embodiments.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

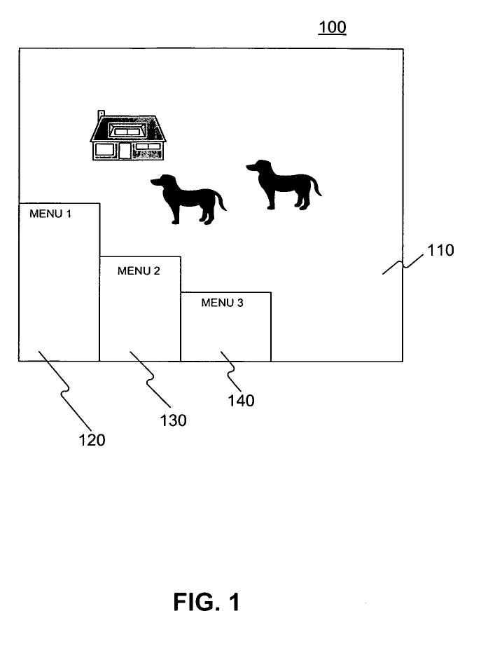

FIG. 1 shows an exemplary OSD display screen consistent with disclosed embodiments. As shown in FIG. 1, OSD display screen 100 includes a video display 110 and a plurality of menus 120, 130, and 140. Video display 110 may include any appropriate video information displayed to a user or users to view contents of the video information. For example, video display 110 may include video information such as images, moving pictures, video, text, and other displayable information. Video display 110 may occupy all or any portion of OSD display screen 100.

The plurality of menus 120, 130, and 140 may include any appropriate menus representing certain functional interfaces for the user or users to perform certain interactive functionalities, such as to control or configure display contents, to set up or configure display devices, and/or to set up or configure display sources or display options, etc. Display screen 100 is shown for illustrative purposes only, other display portions or display contents may also be included in display screen 100.

One or more of menus 120, 130, and 140 may, in whole or in part, be superimposed on video display 110 such that the user or users are able to use menus 120, 130, and 140 to access functional interfaces provided by menus 120, 130, and 140. Each of menus 120, 130, and 140 may also have a certain degree of transparency such that the user or users are able to view the portion of video display 110 that is covered or overlay by the superimposition thereon of any one or more of menus 120, 130, and 140. For example, if video display 110 occupies all of OSD display screen 110, menus 120, 130, and 140 are entirely superimposed on video display 110. On the other hand, if video display 110 does not occupy all of OSD display screen 110, menus 120, 130, and 140 may be entirely, partially, or not superimposed on video display 110.

Further, menus 120, 130, and 140 may have certain hierarchical relationships among themselves, such as having different priority or functional levels. For example, menu 120 may be a main menu or a first level menu, menu 130 may be a sub-menu of menu 120 or a second level menu, and menu 140 may be a sub-menu of menu 130 or a third level menu. Menu 120 may also be referred as the menu with the lowest level, and menu 140 may be referred as the menu with the highest level, with a total of three levels of menus being used. Other configurations, however, may also be used. For example, different levels of menus and different numbers of menus may be included, and different menu positions on OSD display screen 100 may be used. Menus 120, 130, and 140 may also overlap one another.

Further, menus 120, 130, and 140 may have different degrees of transparency. The transparency of a menu as used herein refers to a degree to which a portion of video display 110 overlaid by the menu, or another menu overlaid by the menu can be seen through. Transparency may be defined for a single menu or a group of menus. The transparency degrees of menus 120, 130, and 140 may be determined according to certain algorithms more fully explained below. The range of transparency may be defined by the system or by a user, with a maximum range from 0% to 100%, where 0% corresponds to no transparency, i.e., 100% opacity, and 100% corresponds to complete transparency, i.e., the menu is invisible.

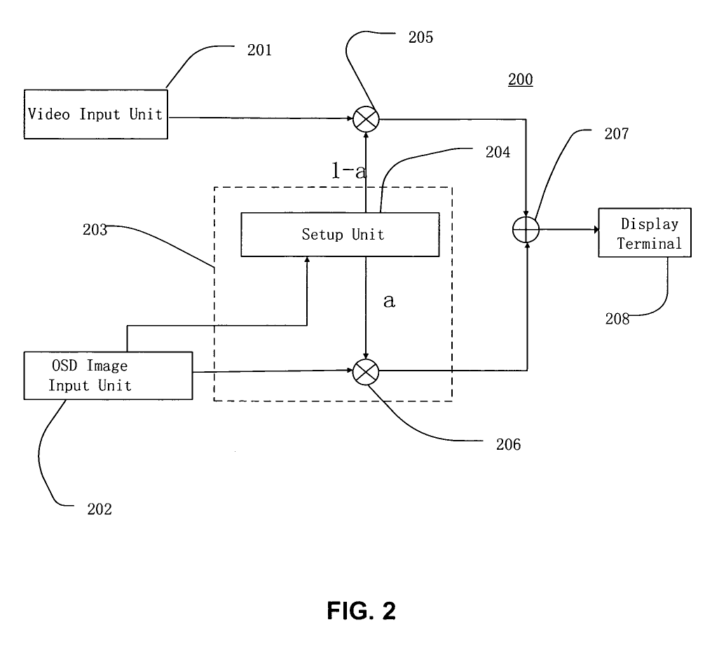

OSD display screen 100 may be generated and controlled by an electronic system having OSD capability, i.e., an OSD capable system. FIG. 2 shows an exemplary electronic system 200 incorporating features consistent with disclosed embodiments. As shown in FIG. 2, electronic system 200 includes a video input unit 201, an OSD image input unit 202, an OSD transparency processing unit 203, a setup unit 204, a first multiplier 205, a second multiplier 206, an adder 207 and a display terminal 208, configured as shown in FIG. 2. Electronic system 200 is configured as shown for illustrative purposes, while other components or devices may be added and certain components or devices may be removed. Further, any component or device included in electronic system 200 may be implemented in hardware, software, or a combination of hardware and software.

Video input unit 201 may include any appropriate device that receives a video signal input from an external video signal source, such as a video decoder of a TV, VCR, DVD player, or other electronic device, and stores at least one frame of the video signal input. OSD image input unit 202 may include any appropriate device that receives an OSD image signal input. The OSD image signal input may include information about functional interfaces for a user of electronic system 200. For example, the OSD image signal input may include information about OSD menus, such as levels of the menus, content of the menus, positions of the menus, and sizes of menus, etc., and/or information for displaying the OSD menus. Both video input unit 201 and OSD image input unit 202 are coupled to OSD transparency processing unit 203 for OSD transparency processing.

OSD transparency processing unit 203 may include any appropriate device that receives and processes OSD image information and/or video information from OSD image input unit 202 and/or video input unit 201 to determine transparency information for the OSD menus and/or the video signal input. OSD transparency processing unit 203 may receive information, such as display position, display size, and individual menu levels of the OSD menus, from OSD image input unit 202. OSD transparency processing unit 203 may also process the received information and determine degrees of transparency for individual menus, based on certain transparency schemes and/or algorithms. Further, OSD transparency processing unit 203 may generate an OSD output containing the OSD image information with one or more desired transparencies set for the OSD menus.

OSD transparency processing unit 203 also determines transparency information for, at least, the portion(s) of the video signal, i.e., video frames, superimposed by the OSD menus. For example, based on OSD information of the OSD menus, such as the transparency, the display position, and display size of the OSD menus, OSD transparency processing unit 203 may determine the transparency of any portion of the video signal that is superimposed by the OSD menu. OSD transparency processing unit 203 generates menu transparency information needed for processing the video signal provided by video signal input unit 201.

OSD transparency processing unit 203 includes setup unit 204 for processing and controlling the OSD transparency information associated with the OSD menus and the corresponding video signal. Setup unit 204 may use one or more transparency schemes for controlling or determining the transparency of the OSD menus. For example, setup unit 204 may use a scheme that increases the transparency degree of an OSD menu when the level of the OSD menu decreases (a higher transparency for a lower menu level), or may use another scheme that decreases the transparency degree of an OSD menu when the level of the OSD menu decreases (a lower transparency for a higher menu level).

Setup unit 204 may also use another scheme that sets menus of the same menu level to ensure radial transparency. Radial transparency, as used herein, may refer to the transparency of a menu or menus of the same level that is gradually changed. For example, the transparency of a menu may change gradually from one side of the menu to another side of the menu, e.g., the transparency is gradually increased from 30% on the left side to 50% on the right side. Further, the transparency may change not only from one side to another side, but also from the center to the edge of the menu and the like. For example, the transparency may also gradually change from the center to edges such that the most transparent area is located at the center of the menu and the least transparent area is located at the periphery of the menu. However, the radial transparency of the menu or menus may be limited by the transparencies of the menus at next levels (i.e., next higher level and next lower level) such that the radial transparency does not overlap with transparencies of the menus at the next levels.

In addition, setup unit 204 may use another scheme, alone or in combination with other schemes, based on relationships between the OSD menus and the video signal. For example, if there is a relationship between the video signal and an OSD menu, e.g., the OSD menu is used to set up options related to the video signal in device configuration, channel selection, display configuration, etc., the transparency of the OSD menus may be increased or decreased based on the relationship. A closer relationship between an OSD menu or menus and contents of the video signal may determine a higher transparency degree.

Further, as shown in FIG. 2, setup unit 204 sets the transparency of the OSD menus as a parameter ‘a’ and sets the corresponding transparency of the video signal as ‘1-a’. That is, the transparency information of OSD menus is represented with parameter ‘a’ to indicate the transparency information to be added to or combined with the OSD image input; and the transparency information of the video signal to be superimposed by the OSD menus is represented with parameter ‘1-a’ to indicate the remaining transparency of the video signal for the portions to be superimposed by the OSD menus with transparency ‘a’. For example, if an OSD menu has a transparency degree of 60%, a remaining transparency of 1−60% 32 40% is to be applied to the portion of the video signal or video frames to be superimposed by the OSD menu. That is, the corresponding video signal is adjusted for transparency of the OSD menu to reflect the effect as being viewed through a partially transparent menu layer. The values of ‘a’ and corresponding ‘1-a’ will change depending on the portions of image and the video signal. For video signal portions that are not superimposed by the OSD menus, no transparency information or transparency processing may be needed.

Parameter ‘a’ may also refer to a set of transparency parameters for a plurality of menus, and parameter ‘1-a’ may represent transparency information of the portions of video signal superimposed by the plurality of menus, with different transparency degrees.

Setup unit 204 is coupled to second multiplier 206 to provide the transparency information of the OSD menus to be combined with the OSD image information from OSD image input unit 202, which is also coupled to second multiplier 206. Further, setup unit 204 is coupled to first multiplier 205 to provide the transparency information for the superimposed portion of the video signal. Video input unit 201 is also coupled to first multiplier 205 to combine the video signal with the transparency information for the superimposed portion. First multiplier 205 and second multiplier 206 may include any appropriate types of analog or digital multipliers.

Further, first multiplier 205 and second multiplier 206 are coupled to adder 207. Adder 207 may include any appropriate type of analog or digital adder for combining the output from first multiplier 205, which is the video signal combined with the transparency information ‘1-a’ from setup unit 204, and the output of second multiplier 206, which is the OSD image information combined with the transparency information ‘a’ from setup unit 204.

The combined signal, i.e., the video signal superimposed by the OSD image with desired transparency for OSD menus, is outputted by adder 207 to display terminal 208 for display. Display terminal 208 may include any appropriate type of display device, such as a TV screen, a computer terminal screen, or a display of an electronic device, etc. Display terminal 208 may receive the combined signal outputted from adder 207 through various paths. For example, display terminal 208 may receive the combined signal via a direct connection to adder 207, via an external wired or wireless connection, or via a broadcasting channel. Other paths may also be used. Display terminal 208 may display the combined signal as shown in FIG. 1. Other information may also be included in the OSD image signal input and displayed through display terminal 208.

It is understood that the above configuration is explained for illustrative purposes. Other configurations may also be used. For example, instead of using the combination of setup unit 204 and first multiplier 205 to set the video transparency information, OSD transparency processing unit 203 may add an alpha channel for transparency information for every level of the OSD menus, and the alpha channel for each menu level may use different transparency and/or transparency processing methods. In case there is no signal input from video input unit 201, display terminal 208 can still receive the OSD image information and display the OSD menus accordingly.

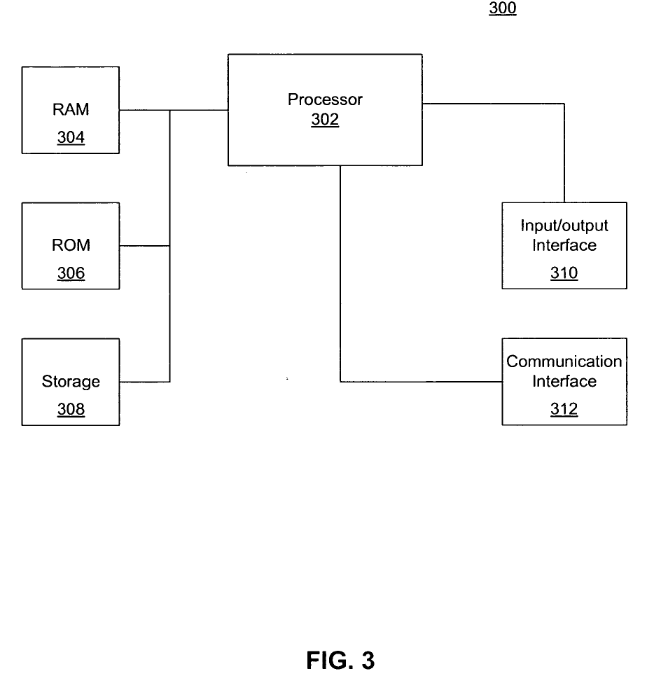

Operations of electronic system 200 and/or OSD transparency processing unit 203 may be controlled by a controller (not shown in FIG. 2). FIG. 3 shows an exemplary controller 300 that may be used in electronic system 200 and/or OSD transparency processing unit 203. As shown in FIG. 3, controller 300 includes a processor 302, a random access memory (RAM) 304, a read-only memory (ROM) 306, a storage 308, an input/output interface 310, and a communication interface 312. It is understood that the type and number of devices included in controller 300 are exemplary only and not intended to be limiting. The number of listed devices may be changed, certain devices may be removed, and other devices may be added.

Processor 302 may include any appropriate type of general purpose microprocessor, digital signal processor, application specific integrated circuit (ASIC), or microcontroller. Processor 302 may execute sequences of computer program instructions to perform various information processing functions and control functions. Processor 302 may be coupled to or access other devices, such as transceivers, other processors, radio frequency (RF) devices, and/or antennas.

RAM 304 and ROM 306 may include any appropriate type of random access memory, read only memory, or flash memory. Storage 308 may include any appropriate type of mass storage provided to store any type of information that processor 302 may need to perform processing/functions. For example, storage 308 may include one or more hard disk devices, optical disk devices, flash memory disks, floppy disk devices, and/or other storage devices to provide storage space.

Input/output interface 310 may send control and data signals to other devices from processor 302 and may receive control and data signals sent from other devices to processor 302. Communication interface 312 may provide communication connections to enable controller 300 to exchange information with other systems via, for example, computer networks, such as the Internet.

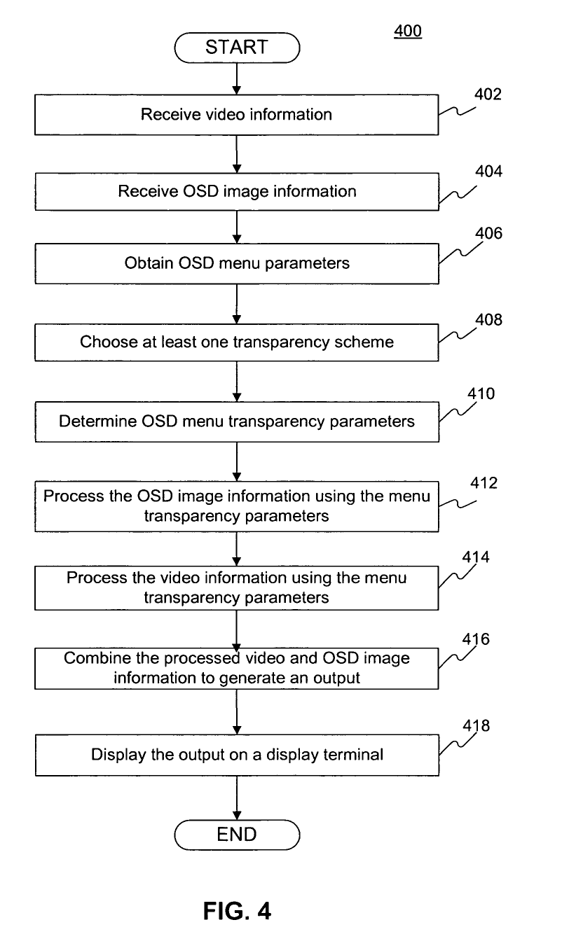

During operation, electronic system 200 may perform various operations or steps to provide OSD functionalities. FIG. 4 illustrates an exemplary operational process 400 performed or caused to be performed by electronic system 200/OSD transparency processing unit 203 and, more particularly, by controller 300/processor 302 of electronic system 200/OSD transparency processing unit 203.

As shown in FIG. 4, processor 302 receives video information (402). For example, processor 302 may cause video input unit 201 to receive video information or video signals from various video sources (402). Processor 302 receives OSD image information (404). For example, processor 302 may cause OSD image input unit 202 to receive OSD image information (404). The OSD image information may include information about OSD menus such as menu level, display position, size, menu relationships, and other display information. Further, processor 302 may obtain OSD menu information from the OSD image information (406). For example, processor 302 may obtain information on the total number of the OSD menus included, total levels of the OSD menus, relationships among the OSD menus, and other characteristics of individual OSD menus from the OSD image information. The relationships may reflect menu and submenu relationship or other inter-menu relationships, and the characteristics may include a particular menu level, display position, color, and size of an individual OSD menu, etc.

Further, processor 302 may choose at least one transparency scheme (408). Processor 302 may choose the transparency scheme from a list of transparency schemes. The list of transparency schemes may be predetermined or generated in real-time, and may include any appropriate transparency schemes. For example, the list may include, as explained previously, a transparency scheme setting a higher transparency for a lower menu level, a transparency scheme setting a lower transparency for a higher menu level, a transparency scheme setting radial transparency for menus at the same level, and a transparency scheme setting a higher transparency for menus with closer relationships with the video signal, etc. Other transparency schemes may also be included.

A transparency scheme may also include an algorithm to calculate a particular transparency degree. For example, a transparency scheme may include an algorithm based on an arithmetic series or a sequence for calculating transparency degrees of the OSD menus. For example, transparency degrees between the highest transparency and the lowest transparency may be calculated using an arithmetic series. In such a case, for example, if the transparency degree increases when the menu level increases, and if the transparency degrees for the lowest menu level and highest menu level are 20% and 80%, respectively, and there are a total of four menu levels, processor 302 may, according to the arithmetic series, set the transparency degrees for the first menu level as 20%, the second menu level as 40%, the third menu level as 60% and the fourth menu level as 80%. That is, the transparency degree arithmetically linearly increases with an increase in the menu level. The transparency degree can also arithmetically decrease when the menu level increases. Further, the increase or decrease may be nonlinear, as prescribed by the arithmetic series.

A transparency scheme may also include an algorithm based on a Fibonacci series or sequence. In the above example, processor 302 may also set the transparency degrees according to a Fibonacci sequence as 20% for the first menu level, 30% for the second menu level, 50% for the third menu level, and 80% for the fourth menu level. That is, the transparency degree may increase in a Fibonacci sequence when the menu level increases. Other algorithms may also be used.

After choosing the at least one transparency scheme (408), processor 302 may determine OSD menu transparency parameters (410). For example, processor 302 may determine for each individual ODS menu a transparency degree based on the OSD menu information (e.g., levels of the OSD menus) and the transparency scheme. For example, if there are four OSD menus and each OSD menu has a different level from a range of transparency of 20% to 80%, processor 302 may determine the transparency of the four OSD menus at 20%, 40%, 60%, and 80%, respectively, as explained above.

Further, processor 302 may process the OSD image information using the menu transparency parameters (412). For example, processor 302 may set the menus in the OSD image information with the determined transparency parameters using second multiplier 206. Processor 302 may also process the video information using the menu transparency parameters (414). That is, processor 302 may adjust or cause adjustment to the portions of the video information to be superimposed by the OSD menus to the effect of being viewed through the OSD menus with the determined transparency. For example, as explained previously, processor 302 may use first multiplier 205 to apply remaining transparency level ‘1-a’ to the corresponding portion of the video information or may use one or more alpha channels to adjust the video information.

After processing the OSD image information (412), and processing the video information (414), processor 302 may combine the processed OSD image information and the processed video information to generate an output for display (416). For example, processor 302 may cause adder 207 to combine the processed OSD image information with desired menu transparency and the processed video information with a desired transparency adjustment. Adder 207 may also provide the combined information as an output for display.

Processor 302 may display the output on a display terminal (418). For example, processor 302 may cause the output to be received by display terminal 208 and display terminal 208 may display the output including the video information and the OSD menus to a user or users.

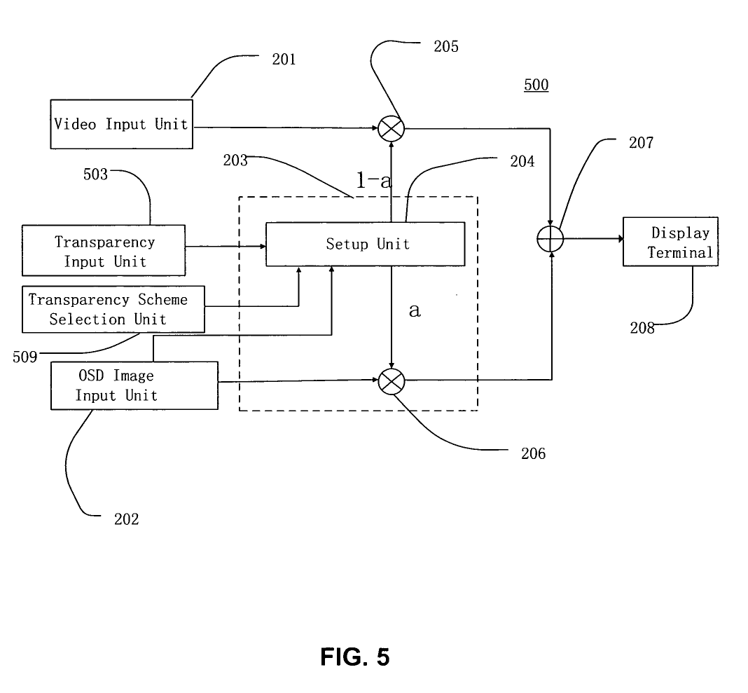

FIG. 5 shows another exemplary electronic system 500 incorporating features consistent with disclosed embodiments. As shown in FIG. 5, electronic system 500 includes existing components of electronic system 200 as shown in FIG. 2 and additional components such as a transparency input unit 503 and a transparency scheme selection unit 509.

Transparency input unit 503 may include any appropriate device, such as a keyboard or a remote control device, that allows a user to enter transparency parameters for the OSD menus. Transparency input unit 503 is coupled to transparency processing unit 203 such that the transparency parameters entered by the user can be provided to setup unit 204. Further, transparency input unit 503 allows the user to enter transparency parameters in different ways. For example, transparency input unit 503 may allow the user to enter a specific transparency degree for each menu level. Transparency input unit 503 may also allow the user to enter transparency parameters for a few particular menu levels, such as the lowest menu level (the first level) and the highest menu level (the last level).

Further, transparency scheme selection unit 509 may include any appropriate device, such as a keyboard or a remote control device, that allows the user to select a transparency scheme or schemes. In certain circumstances, transparency scheme selection unit 509 may be subsumed within transparency input unit 503. Transparency scheme selection unit 509 allows the user to select a transparency scheme for OSD menus of different levels and/or for OSD menus of the same level. For example, transparency scheme selection unit 509 allows the user to select a transparency scheme setting a higher transparency for a lower menu level, a transparency scheme setting a lower transparency for a higher menu level, a transparency scheme setting radial transparency degrees for menus at the same level (with radial transparency degrees not exceeding a transparency degree of the next or previous menu level), and/or a transparency scheme setting a higher transparency for menus with closer relationships with the video signal, etc. Transparency scheme selection unit 509 may also allow the user to combine more than one scheme to be used together. Further, transparency scheme selection unit 509 may also allow the user to choose an algorithm for calculating the transparency degrees, such as using an arithmetic sequence or a Fibonacci sequence.

Electronic system 500 may also include certain components of electronic system 200, such as video input unit 201, OSD image input unit 202, OSD transparency processing unit 203, setup unit 204, first multiplier 205, second multiplier 206, adder 207 and display terminal 208. These components of electronic system 500 perform substantially the same functions described for electronic system 200, except for adding certain functionalities to incorporate transparency input unit 503 and transparency scheme selection unit 509.

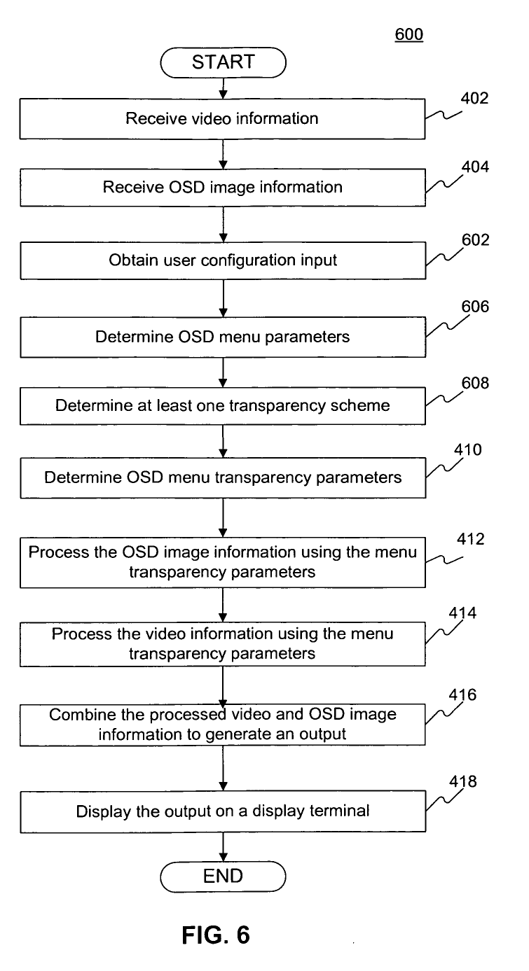

FIG. 6 illustrates an exemplary operational process 600 performed or caused to be performed by electronic system 500. This exemplary operational process includes several operations or steps substantially the same as those shown in FIG. 4, such as 402, 404, 410, 412, 414, 416, and 418.

As shown in FIG. 6, after receiving video information (402) and OSD image information (404), processor 302 may obtain user configuration input (602). For example, processor 302 may obtain transparency parameters or settings from a user via transparency input unit 503 interactively. The user may set different menu levels for different OSD menus, set transparency degrees for different menus or menus levels, and/or configure other OSD menu characteristics, etc. Processor 302 may also obtain transparency scheme selection or additional user-defined transparency schemes from the user via transparency scheme selection unit 509. Other user configurations or configuration parameters may also be obtained.

After obtaining the user configuration input (602), processor 302 may determine OSD menu parameters (606). For example, processor 302 may determine information on the total number of the OSD menus included, total levels of the OSD menus, relationships among the OSD menus, and other characteristics of individual OSD menus. The relationships may reflect menu and submenu relationships or other inter-menu relationships, and the characteristics may include a particular menu level, display position, color, and size of the individual OSD menus. If any of this information is configured by the user, processor 302 obtains such information from transparency input unit 503. On the other hand, if the user does not configure any or all of this information, processor 302 may receive such information from OSD input unit 202 or from certain default information. For example, if the user only sets transparency degrees for the lowest menu level and the highest menu level, processor 302 may further determine transparency degrees for all menu levels based on an arithmetic or Fibonacci sequence.

Further, processor 302 may determine at least one transparency scheme based on any transparency scheme input from the user via transparency scheme selection unit 509 (608). If the user does not select any or all of desired transparency schemes and algorithms, processor 302 may determine one or more transparency schemes as described previously for operation 408 shown in FIG. 4.

After determining the OSD menu parameters (606) and the transparency schemes (608), processor 302 may continue to perform operations or steps 410, 412, 414, 416, and 418 (as described above with reference to FIG. 4) to display desired video information superimposed by the OSD menus.

By determining transparency degrees according to the levels of the OSD menus, the OSD menus can be displayed with different transparency degrees so that a user may judge the menu levels directly from the different transparency degrees when operating with the OSD menus. Moreover, when menus of different levels show different transparency degrees, the entire menu display will present a strong sense of orderly arrangement, which can help the user eliminate a sense of disorder resulting from menus of different levels displayed with the same transparency degree and thus should provide a better user experience for the user. In addition, by allowing the user to customize the transparency parameters and the transparency scheme to the user's specific needs, the flexibility of the user's utilization of the menus is significantly increased.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for operating an on-screen display (OSD) capable system, comprising:
receiving video information from a video source;
receiving OSD image information including a plurality of menus with different menu levels;
determining respective transparency degrees of the plurality of menus; and
generating an output signal to be displayed on a display terminal, wherein the output signal represents the video information superimposed by the plurality of menus with the determined transparency degrees.

2. The method according to claim 1, wherein the plurality of the menus have different menu levels, and the respective transparency degrees of the plurality of menus correspond to the different menu levels.

3. The method according to claim 1, wherein the determining includes:
receiving menu parameters based on the OSD image information, the menu parameters including the menu levels of the plurality of menus;
choosing at least one transparency scheme; and
determining the transparency degrees of the plurality of menus based on the menu levels and the at least one transparency scheme.

4. The method according to claim 3, further including setting the menu levels of the plurality of menus based on a user configuration input.

5. The method according to claim 3, wherein the choosing further includes choosing the at least one transparency scheme based on a user configuration input.

6. The method according to claim 3, further including
setting, in accordance with the at least one transparency scheme, a higher transparency degree for a menu with a higher menu level based on one of an arithmetic sequence and a Fibonacci sequence.

7. The method according to claim 3, further including setting, in accordance with the at least one transparency scheme, a higher transparency degree for a menu with a lower menu level based on one of an arithmetic sequence and a Fibonacci sequence.

8. The method according to claim 3, further including
setting, in accordance with the at least one transparency scheme, radial transparency degrees for menus with a same menu level.

9. The method according to claim 3, further including
setting, in accordance with the at least one transparency scheme, transparency degrees for the plurality of menus based on a relationship between the video information and the plurality of menus.

10. The method according to claim 1, wherein the generating includes:
processing the OSD image information to set the plurality of menus with the determined transparency degrees;
processing the video information to set transparency of one or more portions of the video information that is superimposed by the plurality of menus based upon the determined transparency degrees; and
combining the processed OSD image information and the processed video information into the output signal such that the video information is superimposed by the plurality of menus with the determined transparency degrees.

11. The method according to claim 10, wherein a parameter ‘a’ represents transparencies of the plurality of menus, the processing of the video information further including:
processing the video information using a transparency parameter ‘1-a’ for the one or more portions of the video information that are superimposed by the plurality of menus.

12. The method according to claim 1, further comprising:
displaying the output signal.

13. An on-screen display (OSD) capable system, comprising:
a video input unit configured to receive video information from a video source;
an OSD image input unit configured to receive OSD image information including a plurality of menus with different menu levels;
a transparency processing unit coupled to the video input unit and the OSD image input unit and configured to determine respective transparency degrees of the plurality of menus based on the different menu levels; and
an adder coupled to the transparency processing unit to provide an output signal to be displayed, wherein the output signal represents the video information superimposed by the plurality of menus with the determined transparency degrees.

14. The method according to claim 13, wherein the plurality of the menus have different menu levels, and the respective transparency degrees of the plurality of menus correspond to the different menu levels.

15. The system according to claim 13, wherein the transparency processing unit is configured to
determine the menu levels of the plurality of menus;
choose at least one transparency scheme; and
determine the transparency degrees of the plurality of menus based on the menu levels and the at least one transparency scheme.

16. The system according to claim 15, further comprising:
a transparency input unit coupled to the transparency processing unit to obtain the menu levels of the plurality of menus based on a user configuration input to the transparency input unit.

17. The system according to claim 15, further comprising:
a transparency scheme selection unit coupled to the transparency processing unit to select the at least one transparency scheme based on a user configuration input.

18. The system according to claim 15, wherein, based on the at least one transparency scheme, the transparency processing unit is configured to set a higher transparency degree for a menu with a higher menu level based on one of an arithmetic sequence and a Fibonacci sequence.

19. The system according to claim 15, wherein, based on the at least one transparency scheme, the transparency processing unit is configured to set a higher transparency degree for a menu with a lower menu level based on one of an arithmetic sequence and a Fibonacci sequence.

20. The system according to claim 15, wherein, based on the at least one transparency scheme, the transparency processing unit is configured to set radial transparency degrees for menus with a same menu level.

21. The system according to claim 15, wherein, based on the at least one transparency scheme, the transparency processing unit is configured to set transparency degrees for the plurality of menus based on a relationship between the video information and the plurality of menus.

22. The system according to claim 13, further including:
a setup unit included in the transparency processing unit;
a first multiplexer coupled to the setup unit and the video input unit; and
a second multiplexer coupled to the setup unit and the OSD image input unit,
wherein the setup unit is configured to:
process the video information to set transparency of one or more portions of the video information that is superimposed by the plurality of menus based upon the determined transparency degrees via the first multiplier; and
process the OSD image information to set the plurality of menus with the determined transparency degrees via the second multiplier,
wherein the adder combines the processed OSD image information and the processed video information into the output signal such that the video information is superimposed by the plurality of menus with the determined transparency degrees.

23. The system according to claim 22, wherein a parameter ‘a’ represents transparencies of the plurality of menus, the setup unit being further configured to:
provide the parameter ‘a’ to the second multiplier for processing the OSD image information; and
provide to the first multiplier a transparency parameter ‘1-a’ regarding the one or more portions of the video information that is superimposed by the plurality of menus to process the video information.

24. The system according to claim 13, further comprising:
a display terminal coupled to the adder to display the output signal.
